(19) United States
(12) Patent Application Publication
(10) Pub. No.: US 2002/0167550 A1
(43) Pub. Date: Nov. 14, 2002

(54) Method of controlling an apparatus

(76) Inventors: Josephus Hubertus Eggen, Eindhoven (NL); Elise Anna Walthera Hendrina Van Den Hoven, Eindhoven (NL); Evert Jan Van Loenen, Eindhoven (NL); Esko Olavi Dijk, Eindhoven (NL)

Correspondence Address: Corporate Patent Counsel, U.S. Philips Corporation, 580 White Plains Road, Tarrytown, NY, 10591, US

(21) Appl. No.: 10/127,453

(22) Filed: Apr. 22, 2002

(30) Foreign Application Priority Data
Apr. 23, 2001 (EP) 01201467.6

(51) Int. Cl. G09G 5/00

(52) U.S. Cl. 345/838

(57) ABSTRACT

The invention relates to an apparatus comprising user operable control means for controlling the apparatus, detection means for detecting an object and determining an identity of said object, and associating means for associating control options with said identity, the control means being operable to apply said control options in response to the detection means detecting and identifying said object.

### FIELD OF THE INVENTION

The invention relates to an apparatus comprising user operable control means for controlling the apparatus.

The invention further relates to a method of controlling the above apparatus.

The invention further relates to a computer program product for enabling, when executed on a suitable computing device, said device to function as the above apparatus.

### BACKGROUND OF THE INVENTION

Recent developments in data compression, storage capacity and broad-band networks have made it possible that consumers have access to large quantities of information of various kinds. For example, a database of photos or compressed music files may be stored on the hard disk of a personal computer or dedicated device and browsed by the user. As another example, the world wide web constitutes a huge source of all kinds of information which can be browsed by means of a web browser. As yet another example, an ever increasing number of TV and radio channels can be received through cable or satelite networks.

Selection of information units from a huge collection of information units is a complex task, preventing users to fully exploit the capabilities of modem consumer devices.

### OBJECT AND SUMMARY OF THE INVENTION

It is an object of the invention to provide an improved system and method of the type defined in the opening paragraph, enabling simple access to information units. To that end, the apparatus according to the invention comprises detection means for detecting an object and determining an identity of said object, and associating means for associating control options with said identity, the control means being operable to apply said control options in response to the detection means detecting and identifying said object.

Any type of object that can be found in a home or in an office can be used as an object in an interface of an electronic device. The most important limitations are probably size and weight, since large and heavy stuff cannot be carried easily by the user. Examples of suitable objects are: bottles, pens, souvenirs, cutlery, art, china, toys, paper, boxes, decoration materials, anything which can moved around freely. One could also use prefabricated objects, like a dice-shaped object which has a different function for each side, this would overcome the problem of having too many objects.

Objects, like for example a vase bought in Greece, can be used as a shortcut to a collection of memories, in this case a number of pictures made in Greece. Actually objects can be a shortcut to almost everything from switches to all types of media, like video clips, audio, pictures, smells and experiences. For example a box of tissues could be a link to the VCR which records a certain soap opera when you put this box on top of the VCR. Or an old birthday present could recreate the atmosphere of that particular birthday by placing it on a certain place in the room.

It is possible that two or more persons attribute their memories or feelings to the same single object. In an embodiment of the system according to the invention, the apparatus further comprises person recognition means which enables the apparatus to determine which person puts the object in place, and subsequently control the apparatus in accordance with the control options associated with that particular person. For example, different members of a household may attach different holiday pictures to the same souvenir, and control the apparatus according to the invention to show those pictures in response to placement of the souvenir near the apparatus.

The reason for using objects in interfaces is that they can make complex tasks simple (e.g. trying to find a particular picture in a picture-database of a lifetime is much more easy to do with objects), and they make virtual information physical and thus more understandable, since a lot of the future's information will reach us in bits and bytes (look at the digital camera trend, e.g.).

Objects can be detected by using transponders, but it could also be done with vision recognition or by weight. Detection of an object could be done on top of a device, near a device, on a certain place in the room, or near to where you want the task to be done. This particular place could be marked e.g. with a tablecloth, tape, the shining of a light (you have to put the object in the light). If transponder-technology is used then almost any object can be tagged, and thus users can select their own objects and the amount they want to use. When using weight or vision recognition, no tags are required at all.

### BRIEF DESCRIPTION OF THE DRAWINGS

These and other aspects of the invention are apparent from and will be elucidated, by way of a non-limitative example, with reference to the embodiment(s) described hereinafter. In the drawings,

FIG. 1 schematically shows an apparatus according to the invention; and

FIG. 2 shows a image browser as an apparatus embodying the invention.

### DESCRIPTION OF EMBODIMENTS

A lot of people have image collections, usually stored as a collection of photos in a photo book. However, browsing the photos in a photo book is very time-consuming, since it is essentially a linear process. As more and more people have access to devices such as Photo CD viewers and computers, it seems logical to digitize these photos so they can be managed, sorted and browsed on the computer or on a television screen. Several photo development shops already offer the service of creating a CD-ROM with digital versions of the developed photos.

These digital images can be browsed using an image browsing device. This can be a standalone device, but also a part of another device. For example, it could be a computer program which runs on a general purpose computer and which can read images from a CD-ROM and show them on the computer's display device.

To show the available images to a user, image browsing devices typically operate using thumbnails or other representations of images in the image collection. Such a representation is usually smaller than the actual image, so that a whole sequence of representations can be shown at once on the computer or television screen, rather than just one or two images at a time. A user can select a representation from the sequence using a mouse, keyboard or other input device, and then see the corresponding image.

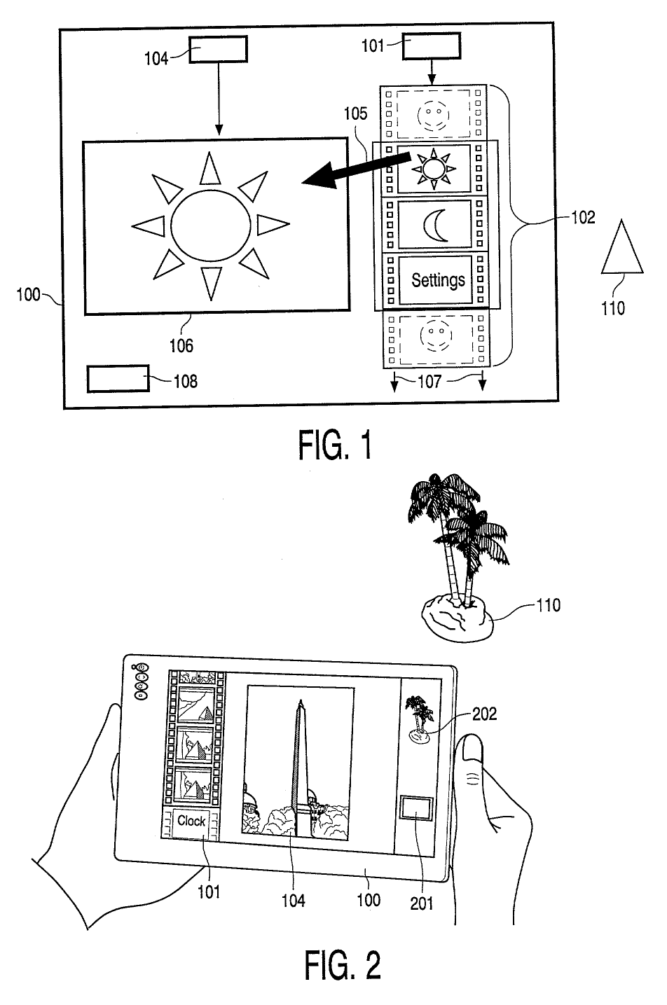

FIG. 1 shows a device 100 for browsing an image collection, comprising browsing means 101 for showing a sequence 102 of representations in a browsing area 103, each representation corresponding to an image from the image collection, or to a control option of the device, e.g. ‘settings’. The device 100 further comprises display means 104 for showing in a display area 106 an image from the image collection. When a user makes a selection 105 from the sequence 102, the image corresponding to the selected representation is shown in the display area 106.

The image collection can comprise a collection of photos, pictures or drawings, where for each photo, picture or drawing a representation is provided. This representation could be an icon or thumbnail, either generated automatically by software or generated manually by a user or operator. The image collection could also comprise one or more video streams. In that case, the representations could be key frames corresponding to portions of the video stream or streams. Selecting a representation will then result in a corresponding moving image, i.e. the corresponding portion of a video stream, being shown.

The browsing area 103 and the display area 106 can for instance be two graphical windows on a computer screen, or be portions of the same window. Using two separate windows allows independent manipulation of the size and the position of each. In hand-held devices such as digital cameras only limited display screen space is available, so there the same display screen is used for both the browsing area 103 and the display area 106, presented next to each other. It may also be useful to present the browsing area 103 and the display area 106 in a wholly or partially overlapping fashion.

The browsing means 101 is arranged to show the sequence 102 by continuously scrolling 107 the sequence 102 in the browsing area 103. The sequence 102 is usually too large to fit in the browsing area 103 completely. This is indicated in FIG. 1 by showing the portions of the sequence 102 that do not fit in the browsing area 103 in a dashed form. The scrolling 107 will result in those portions being shown eventually.

By default, the image browser presents images which are randomly selected from all available images, or it may enable the user to expressly select individual images, specific catagories of images, or precompiled sub-collections of images. Said user selections may, according to the invention, be further achieved by placing an object 110 in the vicinity of the image browser. For example, the object 110 may be a souvenir bought during the most recent holiday trip. The image browser comprises an object detector 108 for detecting the presence of the object 110 in the vicinity of the image browser. Upon detection of the souvenir, the image browser starts to present holiday pictures of that specific holiday trip.

FIG. 2 shows the apparatus 100 implemented as a hand-held touch screen device and the souvenir 110 placed nearby the device 100. A transponder is attached to the souvenir to enable it to be detected by the image browser 100. On the left the ‘negative roll’ is visible, while the enlarged picture can be found in the middle and icons 201 for the big screen and 202 for an object on the upper-right. The palm tree object is put near the device such that the portable device detects it; this is indicated by an icon of the object.

Any physical object that has a tag can be used for the portable photo-browsing device. The idea is that one places the object somewhere near the touch screen and that the content of the presented roll of images is then changed depending on the object, according to the people present in the room (e.g. the people near the device) and it will give sound feedback (in the case of the palm tree shown in FIG. 2, birds start singing). Immediately after the roll changed one can take away the object and the roll will keep its content, it doesn't change back automatically, it will only do that when one presses a frame corresponding to a control option, e.g. a black frame with caption ‘go back’, or any other suitable command. The touch screen will give sound feedback when it discovers that an object is placed within the detection range of the receiver.

If an object is not linked to certain pictures then the roll will only show ‘go back’.

If the object is linked to certain pictures then the following thumbnails will be available: ‘go back’ (black frame) and all the frames containing the thumbnails of linked pictures (blue frames).

To remind users of the existence of objects it could be useful to add a frame to the ‘suggestions’ with the following text: ‘try putting an object on the table’.

The idea of the tags is that users can stick them to any object they want and then they can add a link to that tag. If, for whatever reason, this tag is removed and placed on another object than the link remains. The user can change the content of this link, so she is in control.

One can add a picture to the object by dragging an enlarged picture to the icon of the object. In this way one has to decide beforehand which picture one wants to add to the object, enlarge that one, place the object near the touch screen and drag the enlarged picture to the object's icon. If one would like to add more pictures one would have to remove the object, press ‘go back’ and enlarge another picture (this could also be done by removing the enlarged picture which lies on top of the stack, so that another enlarged picture appears from underneath the previous one). Another way of adding a picture to an object is by dragging it directly from the original roll to the object-icon.

Deleting a link to a picture can be done explicitly by the user. Alternatively, the system will decide when to make certain pictures disappear and it will do so without warning the user. For example, somebody has been using this object a lot recently but she has never enlarged this one picture which is linked to it. The systems agents suggest this picture to her and when she then still does not enlarge it it will disappear from the object but stay in the original database which can be entered from the portable devices moving roll.

In the example described above it could also be very useful for an object to always attach itself to the most recent set of pictures, then the object represents ‘new pics’. (With the future possibilities in digital cameras this is no problem, since every picture taken gets a time and location stamp.) Another object could stand for ‘all Anne's pictures’. If Anne then takes this object to a friend she can also use it there or use it as a gift for this friend. This friend can then decide to keep the links and maybe add new ones or delete old ones. Objects could also stand for a particular preference in showing a set of associated pictures, e.g. a box-shaped object could be used to show a slideshow on a big screen of all the pictures associated to the object you put inside this box. One could even use a collection of objects in stead of the portable device. You only need one projection screen, but this could also be a television set or a future poster frame.

A second way of using objects (besides a direct link or association) is as filters. For example in the case of a photo browser you could also use objects to narrow-down a search for a particular picture or set of pictures. Then the palm tree would mean ‘look for all pictures with palm trees in them, or look for pictures of sunny places’. If you would add a second object then the search would have two constraints, e.g. pictures with palm trees and cars in them (if the second object is a toy-car). The implementation could be done with a vision recognition system.

The invention is not limited to image browsing applications. In an alternative embodiment, the apparatus according to the invention is a television receiver capable of receiving a plurality of TV channels or playing back TV programs from a storage device (e.g. a harddisk, a DVD player/recorder or a VCR). Upon detection of a tagged object near the television receiver, a particular user profile in accordance with with the detected object and the person putting it there may be activated. This activation may cause particular channels to be temporarily left out from the available channels, or programs to be filtered in accordance with particular preferences.

Physical objects may also applied for controlling an apparatus according to the invention in the following scenarios:

1) Objects representing the state of a system and virtual objects. Putting an object near an electronic game tablet, the state of an interrupted game will be displayed. If again the game is interrupted, the new state can be stored into the same or another object.

2) Smart Candle object (represents command or function, e.g. light settings), object positioning and activation depending on the position. As an example, one can put an object on the dinner table, and immediately the lights over the table dim, and the other smart candles on and near the table start to glow. When dinner is finished, the object associated with “cozy light mode in this neighbourhood”, can be removed, causing the lights to return to there previous setting.

3) Objects as presents, representing memories and become a memory, or together with something you buy. You should be able to attach a photo diary or any other type of media to an object and then give it to somebody else as a present. The receiver of the present can then decide what he wants to do with the object, e.g. he can extract, copy or add new media content.

4) Objects seem alive, since they react to the inhabitants dependent on the context. For example, in dependence of a user's choice of music, the objects are moving and/or glowing to the beat of the music.

Although the invention has been described with reference to particular illustrative embodiments, variants and modifications are possible within the scope of the inventive concept. Thus, for example, any suitable technique for communication and detection of physical objects and persons may be used, e.g. transponder technology, Bluetooth, Firefly. The use of the verb ‘to comprise’ and its conjugations does not exclude the presence of elements or steps other than those defined in a claim. In the claims, any reference signs placed between parentheses shall not be construed as limiting the claim. The invention can be implemented by means of hardware comprising several distinct elements, and by means of a suitably programmed computer. In the device claim enumerating several means, several of these means can be embodied by one and the same item of hardware. A ‘computer program’ is to be understood to mean any software product stored on a computer-readable medium, such as a floppy-disk, downloadable via a network, such as the Internet, or marketable in any other manner.

1. An apparatus comprising user operable control means for controlling the apparatus, detection means for detecting an object and determining an identity of said object, and associating means for associating control options with said identity, the control means being operable to apply said control options in response to the detection means detecting and identifying said object.

2. An apparatus as claimed in claim 1, the control means comprising user profile means for maintaining a user profile for at least one user, the control means being operable to apply control options in accordance with said user profile in response to the detection means detecting and identifying said object.

3. An apparatus as claimed in claim 1 or 2, comprising presentation means for presenting a selected information unit from a plurality of information units, wherein said control options applied in respect of the detection and identification of the object comprise a selection of said plurality of information units.

4. An as claimed in claim 3, said information units constituting audio/video content items or still images.

5. An apparatus as claimed in claim 1, said detection means being arranged to recognize a parameter of said object.

6. An apparatus as claimed in claim 5, said parameter being a weight and/or a visual appearance.

7. An apparatus as claimed in claim 1, said detection means utilizing transponder tags attached to the object.

8. A system of an apparatus and an object as claimed in any one of claims 1 to 7.

9. A method of controlling an apparatus, comprising detecting an object and determining an identity of said object, and associating control options with said identity and applying said control options in response to the detection means detecting and identifying said object.

10. A method as claimed in claim 9, comprising presenting a selected information unit from a plurality of information units, wherein said control options applied in respect of the detection and identification of the object establish a selection of said plurality of information units.

11. A computer program product for enabling, when executed on a suitable computing device, said device to function as an apparatus as claimed in any one of claims 1 to 3.
